(19) United States
(12) Patent Application Publication
(10) Pub. No.: US 2026/0003575 A1
(43) Pub. Date: Jan. 1, 2026

(54) CALCULATOR

(71) Applicants: Fujitsu Limited, Kawasaki-shi (JP); Inter-University Research Institute Corporation Research Organization of Information and Systems, Tokyo (JP)

(72) Inventors: Masahiro GOSHIMA, Chiyoda (JP); Yi GE, Bunkyo (JP)

(73) Assignees: Fujitsu Limited, Kawasaki-shi (JP); Inter-University Research Institute Corporation Research Organization of Information and Systems, Tokyo (JP)

(21) Appl. No.: 19/229,569

(22) Filed: Jun. 5, 2025

(30) Foreign Application Priority Data
Jun. 28, 2024 (JP) 2024-105528

(51) Int. Cl. G06F 7/523; G06F 7/50

(52) U.S. Cl. CPC G06F 7/523; G06F 7/50

(57) ABSTRACT

A calculator comprising an array of l×m multiply-accumulate calculators configured to perform, when L and M are both integers of 2 or more and N is an integer of 1 or more, an L×M×N matrix product calculation C=A*B or an L×M×N matrix multiply-accumulate calculation C=A*B+Cin by performing accumulations of outer products Ok of k-th column of A and k-th row of B in an array of L×M accumulators for an integer k of 0 or more and less than N, with respect to an L×N matrix A, an N×M matrix B, an L×M matrix C, and an L×M matrix Cin, wherein any one of l or m is l=L or m=M and the other one is an integer of 2≤l<L or 2≤m<M, and the l×m multiply-accumulate calculators perform each of the accumulations of the outer product Ok by a plurality of steps.

### CROSS-REFERENCE TO RELATED APPLICATION

This application is based upon and claims the benefit of priority of the prior Japanese Patent application No. 2024-105528, filed on Jun. 28, 2024, the entire contents of which are incorporated herein by reference.

### FIELD

The present embodiment relates to a calculator.

### BACKGROUND

In particular, in applications such as artificial intelligence (AI), it is important to increase the speed and power-efficiency of matrix multiply-accumulate (MMVA) calculation of low-precision elements such as FP16 (half-precision floating-point number).

Methods of an MMA calculator include an inner-product type, an outer-product type, and the like.

The MMA calculator stores matrices to be calculated in the layer directly connected to the MMA calculator in the storage hierarchy, such as a register file (RF), and performs calculation while accessing the layer.

For example, a related art is disclosed in Japanese National Publication of International Patent Application No. 2022-506418, and Y. Wang, et al.: Dual-side Sparse Tensor Core, Int'l Symp. on Computer Architecture (ISCA), pp. 1083-1095 (2021).

### SUMMARY

In one aspect, a calculator includes an array of element l×m multiply-accumulate calculators configured to perform, when L and M are both integers of 2 or more and N is an integer of 1 or more, an L×M×N matrix product calculation C=A*B or an L×M×N matrix multiply-accumulate calculation C=A*B+Cin by performing accumulations of outer products Ok of k-th column of A and k-th row of B in an array of L×M accumulators for an integer k of 0 or more and less than N, with respect to an L×N matrix A, an N×M matrix B, an L×M matrix C, and an L×M matrix Cin, wherein any one of l or m is l=L or m=M and the other one is an integer of 2≤l<L or 2≤m<M, and the l×m multiply-accumulate calculators perform each of the accumulation of the outer product Ok by a plurality of steps.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating a configuration example of a calculation processing device in a related example;

FIG. 2 is a diagram for description of a three-dimensional representation of a matrix product in the related example;

FIG. 3 is a diagram for description of a three-dimensional representation of an L×M×N matrix product in the related example;

FIG. 4 is a table for description of a correspondence relationship between the number of EMAs and the number of steps of each dimension in the related example;

FIG. 5 is a diagram for description of a zero-dimensional MMA calculator in the related example;

FIG. 6 is a diagram for description of a one-dimensional MMA calculator in the related example;

FIG. 7 is a diagram for description of a two-dimensional MMA calculator in the related example;

FIG. 8 is a block diagram schematically illustrating a configuration example of the two-dimensional MMA calculator in the related example;

FIG. 9 is a diagram for description of a three-dimensional MMA calculator in the related example;

FIG. 10 is a diagram for description of the number of times of RF access of the one-dimensional MMA calculator in the related example;

FIG. 11 is a table for description of a correspondence relationship between the number of EMAs of each dimension and the number of steps in the related example and the embodiment;

FIG. 12 is a diagram for description of a 1.5-dimensional MMA calculator according to an embodiment;

FIG. 13 is a diagram for description of a 1.5-dimensional MMA calculator according to a modification;

FIG. 14A is a diagram for description of a one-dimensional middle-product type MMA calculator, and FIG. 14B is a diagram for description of a one-dimensional outer-product type MMA calculator;

FIG. 15 is a table illustrating the number of times of RF access in a case where the peak performance is constant in each method;

FIG. 16 is a block diagram schematically illustrating a configuration example of a 2×8 1.5-dimensional MMA calculator according to the embodiment;

FIG. 17 is a block diagram schematically illustrating a configuration example of a processing element (PE) illustrated in FIG. 16; and

FIG. 18 is a block diagram schematically illustrating a configuration example of a PE corresponding to that of FIG. 13, which has a thickness in the k-axis direction.

### DESCRIPTION OF EMBODIMENT(S)

In particular, in an application such as AI, in a case where the accuracy of data to be operated is low, such as FP16, the power of a fused multiply-add (FMA) calculation of each matrix element is small, and thus the power of RF access relatively increases.

### [A] Related Examples

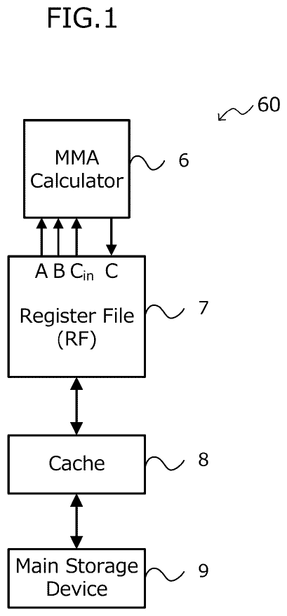

FIG. 1 is a block diagram schematically illustrating a configuration example of a calculation processing device 60 in a related example.

As illustrated in FIG. 1, the calculation processing device 60 includes an MMA calculator 6, a register file (RF) 7, a cache 8, and a main storage device 9. The RF 7, the cache 8, and the main storage device 9 form a storage hierarchy.

The main storage device 9 stores various pieces of data including matrices to be calculated for MMA calculation.

The cache 8 stores a copy of a part of the data stored in the main storage device 9. The cache may be a local memory. In addition, there may be one or more additional levels of caches or local memories in the hierarchy.

The RF 7 stores a copy of a part of the data stored in the cache 8. The RF may be a buffer memory.

The MMA calculator 6 is directly connected to the RF 7 and performs a matrix product or a matrix multiply-accumulate (MMA) calculation on matrices stored in the RF 7. The matrices stored in the RF 7 may be parts of larger matrices. In the example illustrated in FIG. 1, the RF 7 stores matrices A, B, Cin, and C, and the MMA calculator 6 executes MMA calculation C=A*B+Cin.

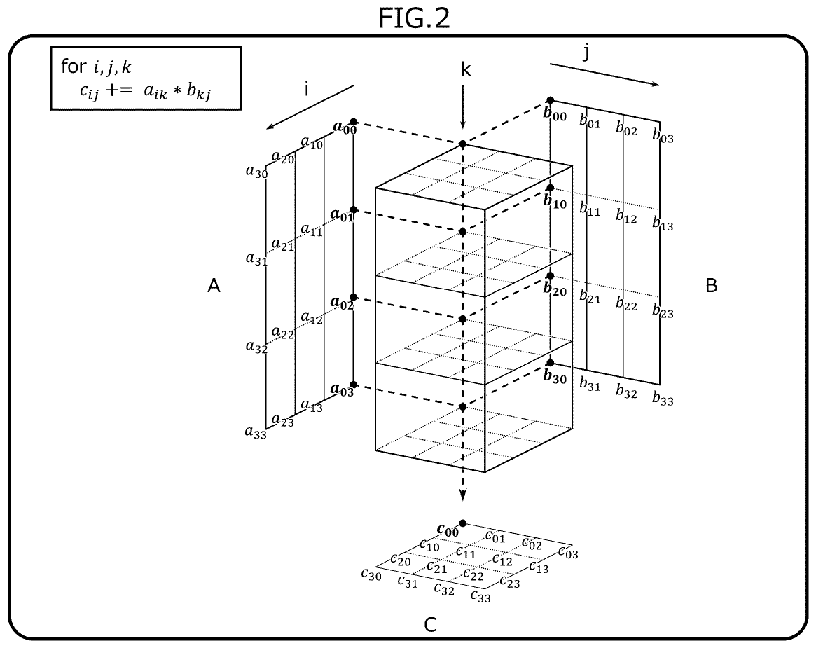

FIG. 2 is a diagram for description of a three-dimensional representation of matrix product in the related example. FIG. 2 assumes a case of matrix product calculation C=A*B for the sake of simplicity, but can be easily extended even in the case of MMA calculation C=A*B+Cin.

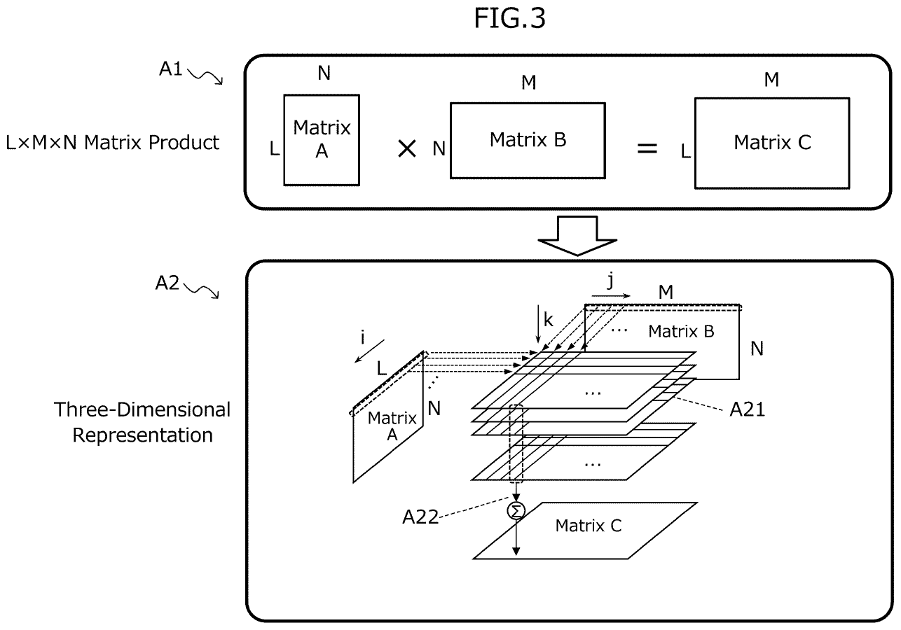

In FIG. 2, a matrix A is defined in an i-k plane, a matrix B is defined in a k-j plane, and a matrix C is defined in an i-j plane. The matrix A is represented by a_{i,k}, the matrix B is represented by b_{k,j}, and the matrix C is represented by c_{i,j}. It is noted that the matrix A is represented rotated by 90 degrees. The same applies to FIGS. 3, 5 to 7, 9, 10, and 12 to 14B.

In FIG. 2, since a three-dimensional representation of 4×4×4 is depicted, i=0 to 3, j=0 to 3, and k=0 to 3.

An FMA calculation is performed at each intersecting point of the central cube. Multiplication (multiply) is performed by multiplying a_{i,k} and b_{k,j} coming from the horizontal direction (i, j direction), and cumulative sum (accumulate) is performed in the vertical direction (k direction). When 4×4×4 intersecting points of the cube are covered by 4×4×4 EMA calculations, typically downward, the matrix product calculation is completed. As illustrated in FIG. 2, in the matrix product calculation, there is no dependency in the horizontal direction, but there is dependency in the vertical direction, and the intermediate cumulative sum is vertically sent.

FIG. 3 is a diagram for description of a three-dimensional representation of an L×M×N matrix product in the related example.

A reference symbol A1 in FIG. 3 represents an L×M×N (L and M are each an integer of 2 or more, and N is an integer of 1 or more) matrix product C=A*B. The matrix A is an L×N matrix, the matrix B is an N×M matrix, and the matrix C is an L×M matrix.

A reference symbol A2 in FIG. 3 indicates a three-dimensional representation of the L×M×N matrix product. The three-dimensional representation is basically similar to that in FIG. 2, but is in consideration of the calculation order of the outer-product type. In each plane indicated by a reference symbol A21, the outer product Ok of k-th column of the matrix A and k-th row of the matrix B, that is, multiplication of all combinations of each element is expressed, and an intersecting point represents the product of the corresponding elements. As indicated by a reference symbol A22, the matrix C is obtained by summing the products of the same i and j of the respective plane in the vertical direction.

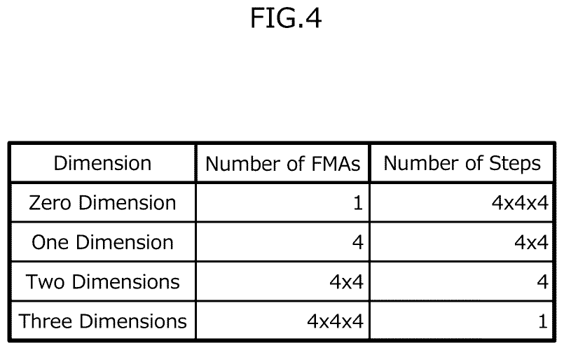

FIG. 4 is a table for description of a correspondence relationship between the number of FMA calculators constituting the MMA calculator and the number of steps in the related example.

In order to cover 4×4×4 FMA calculations with 1 to 4×4×4 EMA calculators, as illustrated in FIG. 4, in zero dimension, the number of EMA calculators is 1 and the number of steps is 4×4×4, and in one dimension, the number of EMA calculators is 4 and the number of steps is 4×4. In addition, in two dimensions, the number of EMA calculators is 4×4 and the number of steps is 4, and in three dimensions, the number of EMA calculators is 4×4×4 and the number of steps is 1.

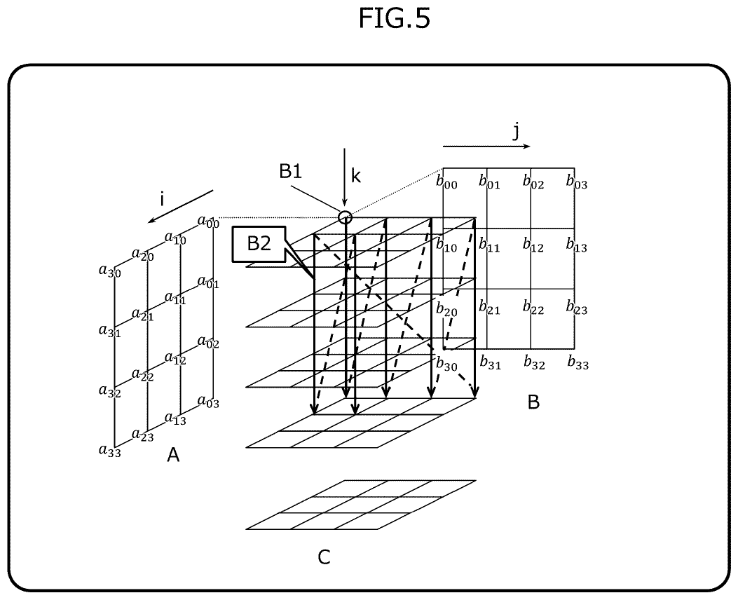

FIG. 5 is a diagram for description of a zero-dimensional MMA calculator 6 in the related example.

As indicated by a reference symbol B1 in FIG. 5, in the zero dimension (point), normal sequential processing of 4×4×4 steps is performed by one FMA calculator.

As the calculation order, generally, an inner-product type ijk (an example indicated by a solid arrow of a reference symbol B2), an middle-product type ikj, and an outer-product type kij are assumed. For example, the calculation order of the inner-product type ijk signifies the order from the outside when expressed by nested for loops as described below, and conversely signifies that processing is performed in the order of k, j, and i from the innermost loop.

```
for i
  for j
    for k
      FMA calculation;
```

The inner-product type ijk is advantageous in the number of times of RF access.

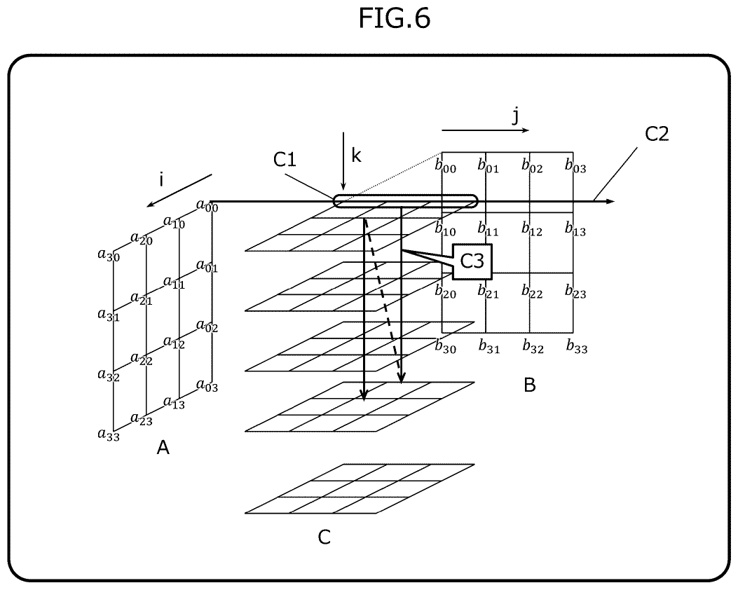

FIG. 6 is a diagram for description of a one-dimensional MMA calculator 6 in the related example.

As indicated by a reference symbol C1 in FIG. 6, in one-dimension (line), processing of 4×4 steps is performed by four FMA calculators. It is noted that a reference symbol C2 indicates a broadcast direction.

Various calculation orders inside the MMA calculator are assumed, but in general, an middle-product type ikj (an example indicated by a solid arrow of a reference symbol C3) is advantageous.

It is noted that, although the outer-product type kij is also conceivable, there is a problem that a large amount of accumulators for storing the intermediate cumulative sum of the matrix C need to be provided, which is not realistic.

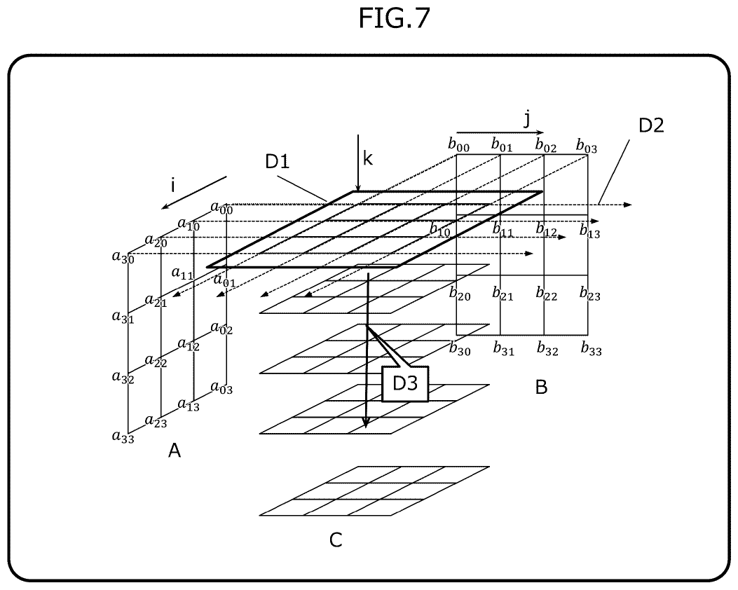

FIG. 7 is a diagram for description of a two-dimensional MMA calculator 6 in the related example.

As indicated by a reference symbol D1 in FIG. 7, in two dimensions (plane), processing of four steps is performed by 4×4 FMA calculators. It is noted that a reference symbol D2 indicates a broadcast direction.

As the calculation order inside the MMA calculator, an outer-product type kij (an example indicated by a solid arrow of a reference symbol D3) is advantageous.

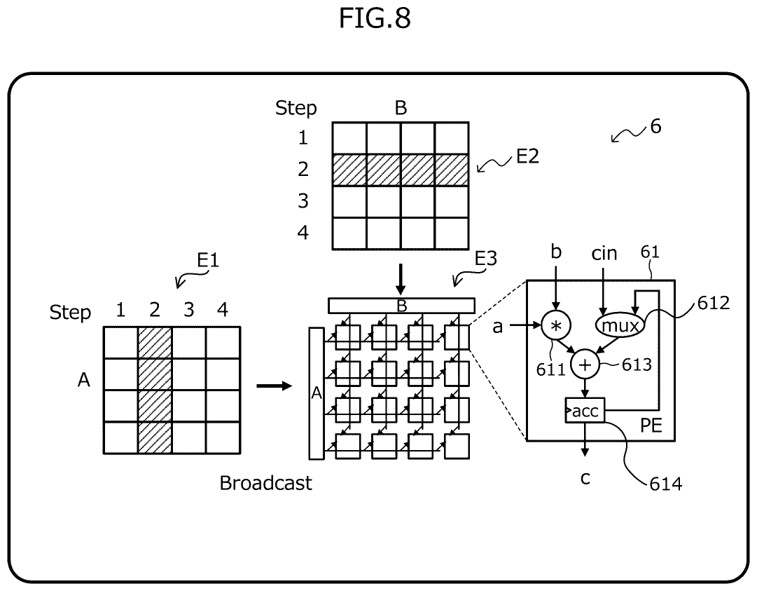

FIG. 8 is a block diagram schematically illustrating a configuration example of a two-dimensional outer product type MMA calculator 6 in the related example. FIG. 8 illustrates an example of a 4×4 outer-product type.

In C=A*B, 4×4 products of all combinations of respective elements in the k-th column of the matrix A and the k-th row of the matrix B are calculated in one step. Then, these products are accumulated for four steps of k=0 to 3 to obtain the matrix product.

In the example illustrated in FIG. 8, in order to calculate the product of 4×4 square matrices, processing elements (PE) 61 are arranged in a 4×4 tile shape.

Each of the four elements of the k-th column of A indicated by a reference symbol E1 and the k-th row of B indicated by a reference symbol E2 is broadcasted in the row or column direction of the tile indicated by a reference symbol E3, and 4×4 multiply-accumulate calculations of all combinations of input elements are executed in one step.

The PE 61 includes a multiplier 611, a multiplexer (mux) 612, an adder 613, and an accumulator (acc) 614 in order to perform the FMA calculation. The multiplier 611 and the adder 613 may be configured as EMA calculators.

The multiplier 611 multiplies a and b. The mux 612 selects and outputs the output of cin or acc 614 in the PE 61. The adder 613 adds the output of multiplier 611 and the output of the mux 612. The acc 614 stores the output of the adder 613 and outputs the output as a calculation result c.

A value is input to the tile indicated by the reference symbol E3 while shifting the column A and the row B in each step (in other words, the cycle). The input column A and row B are broadcasted to each PE 61 in the row or column direction, and the sum of products of all combinations is calculated.

After four steps, the input of all the matrix data is completed, and the calculation result C is stored in the acc 614 of each PE 61.

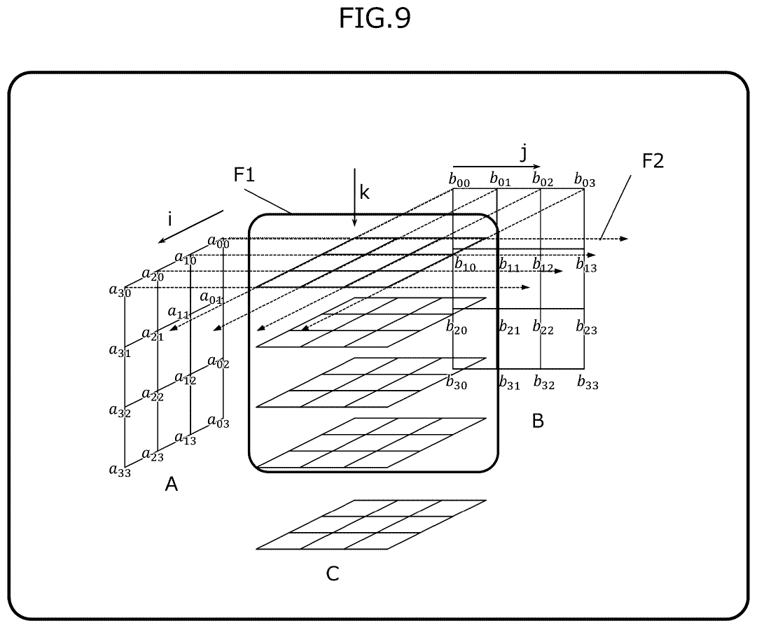

FIG. 9 is a diagram for description of a three-dimensional MMA calculator 6 in the related example.

As indicated by a reference symbol F1 in FIG. 9, in three dimensions (cube), processing of one step is performed by 4×4×4 FMA calculators. It is noted that a reference symbol F2 indicates a broadcast direction.

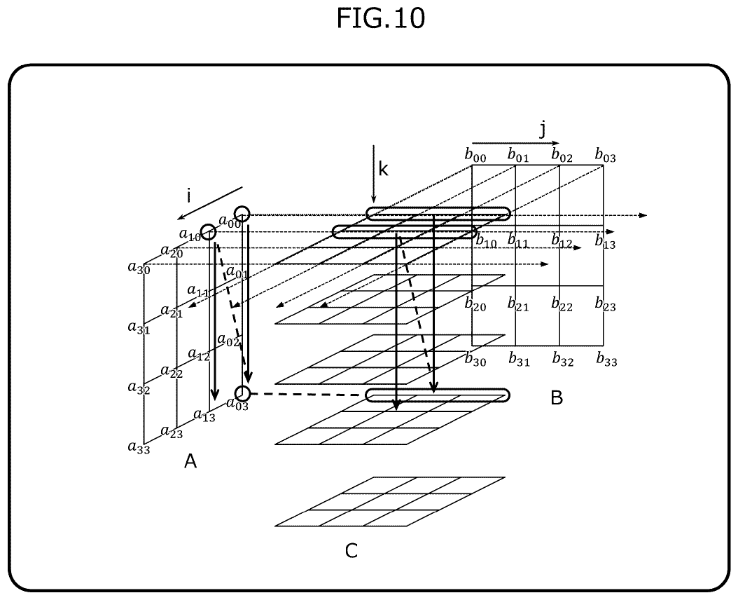

FIG. 10 is a diagram for description of the number of times of RF access of the one-dimensional MMA calculator 6 in the related example.

In the case of a matrix multiply-accumulate C=A*B+Cin of N×N square matrices A, B, Cin, and C, the number of times of RF access per EMA calculation is obtained.

First, the minimum number of times of access is obtained. The total number of times of EMA calculation is N³. On the other hand, the minimum number of times of RF access is N² per matrix, and since there are four matrices of A, B, Cin, and C, the minimum number of times of RF access becomes 4N² in total. Therefore, the minimum number of times of RF access per EMA calculation is 4N²/N³=4/N. That is, the number of times of RF access per EMA calculation decreases as N (matrix size to be calculated) increases. However, actually, there are cases where 4/N is not achievable depending on the method of the MMA calculator.

In the example illustrated in FIG. 10, processing of the middle-product type ikj of 4×4 steps is performed by four one-dimensional (line) FMA calculators.

The elements of the matrix B have low reusability, that is, when calculation is performed up to the bottom a03 of the row a00 of the matrix A and calculation is moved to the next row a10 of the matrix A, b00 to b03 of the matrix B need to be read again. Each element of the matrix B will be accessed N times, and the number of times of access to the matrix B becomes N²×N=N³. Therefore, the number of times of RF access increases from 4N² which is the minimum to 3N²+N³ (A, Cin, C:N², and B:N³).

The reusability of matrix elements once accessed varies depending on each of the zero-dimensional to three-dimensional schemes.

The number of times of RF access is 2N²+2N³ (Cin, C:N², A, B:N³) in the zero dimension, and is 3N²+N³ (A, Cin, C:N², B:N³) in the one dimension. For B (or A), the same element needs to be accessed N times.

In the two and three dimensions, the number of times of RF access is 4N² (A, B, Cin, C:N²). Because all elements are accessed only once, the number of times of RF access is minimized.

### [B] Embodiment

Hereinafter, an embodiment will be described with reference to the drawings. However, the embodiments described below are merely examples, and there is no intention to exclude the application of various modifications and techniques that are not explicitly described in the embodiments. That is, the present embodiment can be variously modified and implemented without departing from the gist thereof. In addition, each drawing is not intended to include only the components illustrated in the drawing, but may include other functions and the like.

Hereinafter, in the drawings, the same reference symbols denote the same parts, and thus the description thereof will be omitted.

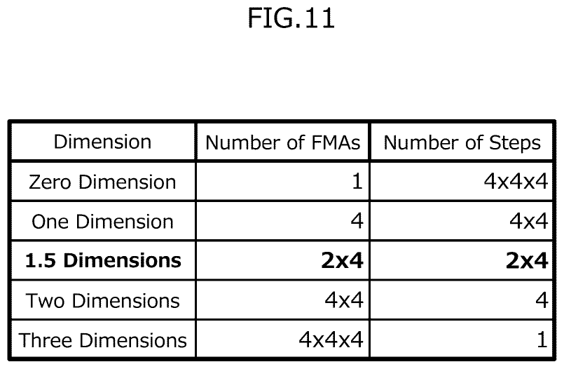

FIG. 11 is a table for description of a correspondence relationship between the number of EMA calculators of each dimension and the number of steps in the related example and the embodiment.

In the table illustrated in FIG. 11, in addition to a correspondence relationship between the number of EMA calculators and the number of steps in zero dimension, one dimension, two dimensions, and three dimensions in the related example illustrated in FIG. 4, the correspondence relationship between the number of EMA calculators and the number of steps in 1.5 dimensions in the embodiment is illustrated.

In the 1.5 dimensions, the number of EMA calculators is 2×4 and the number of steps is 2×4.

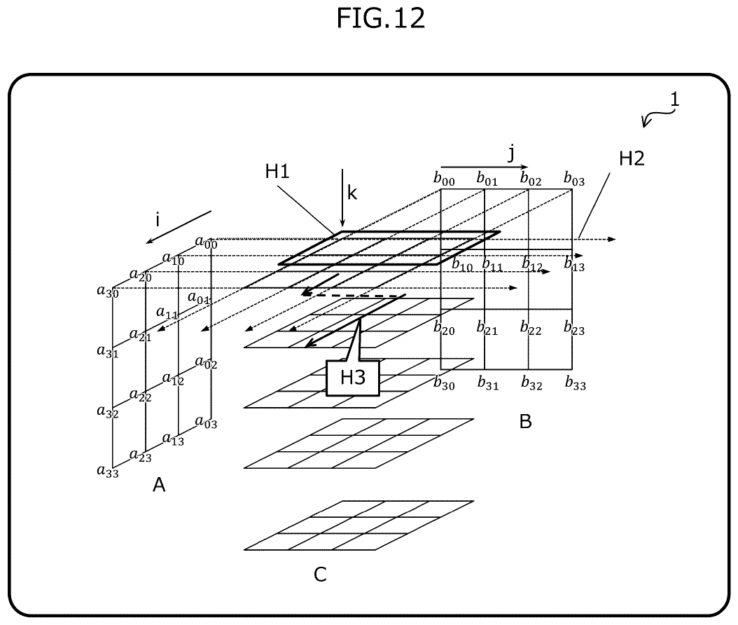

FIG. 12 is a diagram for description of a 1.5-dimensional MMA calculator 1 according to the embodiment.

As indicated by a reference symbol H1 in FIG. 12, in a 1.5-dimensional MMA calculator 1, a 2×4 region in the i-j plane corresponds to one step. It is noted that a dotted arrow denoted by a reference symbol H2 indicates a broadcast direction. In addition, the calculation order is a direction of a solid arrow indicated by a reference symbol H3.

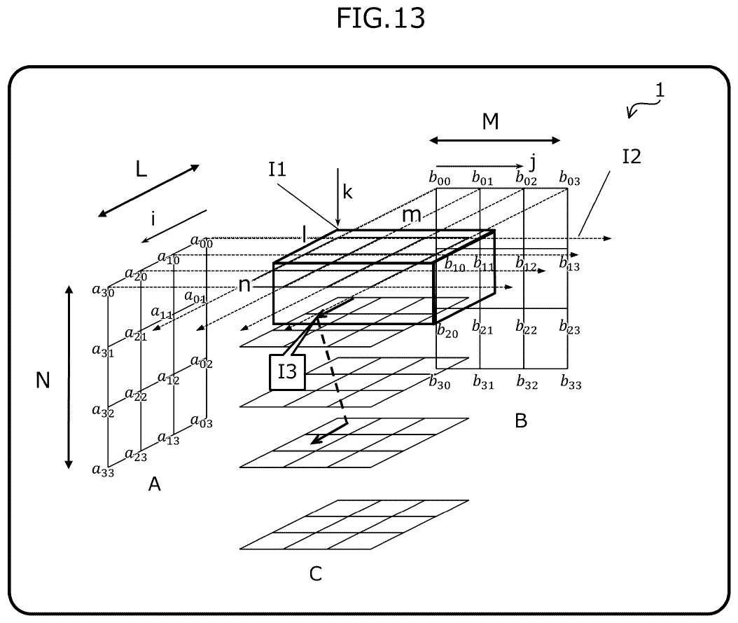

FIG. 13 is a diagram for description of a 1.5-dimensional MMA calculator 1 according to a modification.

One step may have a thickness in the k-axis direction. As indicated by a reference symbol I1 in FIG. 13, in the 1.5-dimensional MMA calculator 1 according to the modification, when A is an L×N matrix, B is an N×M matrix, and C is an L×M matrix, an l×m×n (m=M, 2≤l<L, 1≤n≤N) region is for one step. It is noted that a dotted arrow denoted by a reference symbol I2 indicates a broadcast direction. In addition, the calculation order is a direction of a solid arrow indicated by a reference symbol I3. 1 and m in the i and j directions may be interchanged.

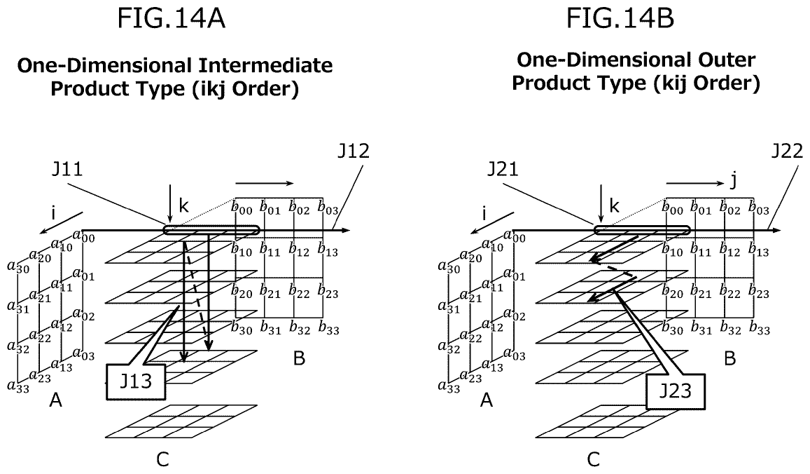

FIG. 14A is a diagram for description of a one-dimensional middle-product type MMA calculator, and FIG. 14B is a diagram for description of a one-dimensional outer product type MMA calculator.

As the calculation order (which order to process i, j, and k) of the one-dimensional type, a general middle-product type (ikj order (processing is performed in the order of j→k→i from the rear)) is assumed, but it is also conceivable to set the calculation order to an outer product type (kij order) of the one-dimensional type. By adopting the outer product type, the number of times of RF access/the number of times of EMA can be further reduced, but the number of accumulator in one PE becomes very large, that is, N, and thus, it is difficult to realize the same.

In the one-dimensional middle-product type (ikj order) illustrated in FIG. 14A, one dimension (line) corresponds to one step, as indicated by a reference symbol J11. It is noted that a solid arrow denoted by a reference symbol J12 indicates a broadcast direction. As indicated by a solid arrow of a reference symbol J13, the calculation order is a direction parallel to the k-axis.

On the other hand, in the one-dimensional outer-product type (kij order) illustrated in FIG. 14B, as indicated by a reference symbol J21, one dimension (line) is equivalent to one step similarly to the middle-product type. It is noted that a solid arrow denoted by a reference symbol J22 indicates a broadcast direction. As indicated by a solid arrow of a reference symbol J23, the calculation order is a direction parallel to the i-axis.

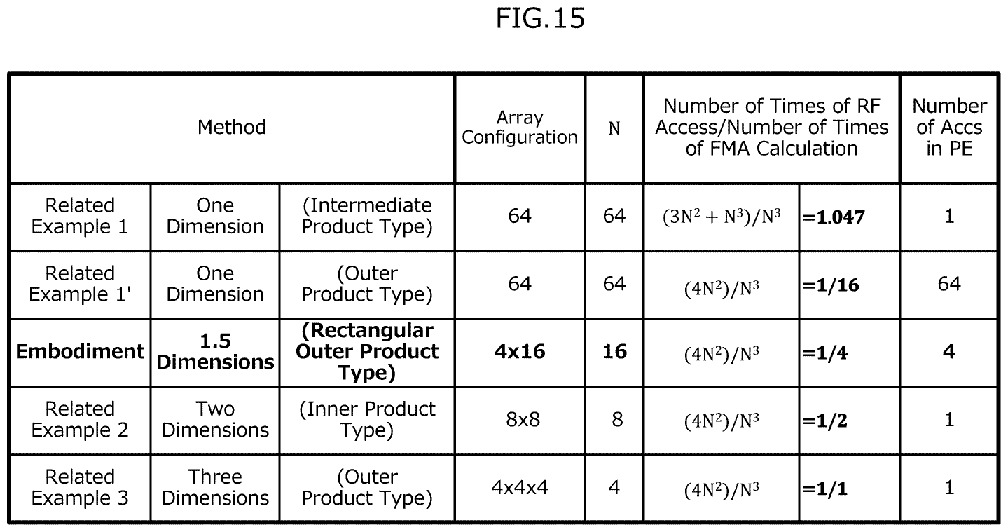

FIG. 15 is a table illustrating the number of times of RF access in a case where peak performance is constant for all the methods.

In the example illustrated in FIG. 15, the number of times of RF access/the number of times of FMA calculation of each method in a case where the MMA calculator includes 64 EMA calculators (thus, the peak calculation performance is the same) is calculated. The size of each dimension (N) of the target matrices varies depending on the methods. According to the 1.5-dimensional MMA (rectangular outer-product type) calculator in the embodiment, the number of times of RF access per EMA calculation can be reduced to half or less as compared with the related examples 1 to 3.

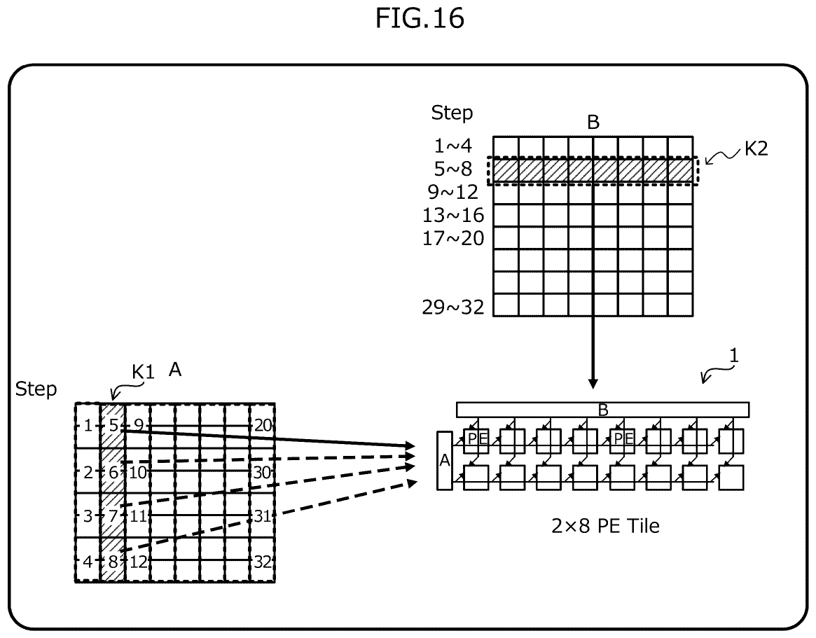

FIG. 16 is a block diagram schematically illustrating a configuration example of a 2×8 1.5-dimensional MMA calculator 1 according to the embodiment.

The 1.5-dimensional MMA calculator 1 is an example of a matrix multiply-accumulate calculator, and may be included in the calculation processing device 60 similarly to the MMA calculator 6 in the related example illustrated in FIG. 1.

A two-dimensional MMA (outer product type) calculator divides elements of the column of the matrix A into groups of a plurality of elements, and performs multiplication of only one group divided in one step. The two-dimensional MMA (outer product type) calculator calculates one step of the outer product type by performing a plurality of steps.

In the example illustrated in FIG. 16, for the sake of simplicity, a case in which the matrix A side is input in a plurality of steps has been described, but the matrices A and B may be interchanged.

In a case in which the number of EMA calculators is the same as that of the two-dimensional MMA calculators, it is possible to increase the target matrix size N according to the present embodiment. As a result, the ratio of the data access amount to be used per calculation amount can be reduced.

In FIG. 16, a product of 8×8 square matrices is calculated. In FIG. 16, the PEs 11 are arranged in a 2×8 tile shape. The elements of one group of the columns of the matrix A (refer to the groups 5 to 8 of a reference symbol K1) and all the elements of the rows of the matrix B (refer to the groups 5 to 8 of a reference symbol K2) are input to the 1.5-dimensional MMA calculator 1 from one side of the tile and broadcasted, and the multiply-accumulate calculation of all the combinations of the input elements is calculated in one step.

The matrix A may be input to the 1.5-dimensional MMA calculator 1 while switching two elements at a time between four steps, and the matrix B may be input to the 1.5-dimensional MMA calculator 1 with all elements of one row only once in four steps. As a result, the number of elements input to the 1.5-dimensional MMA calculator 1 per step is the same between A and B.

The operation of 2×8 matrix multiplication is basically the same as that of the two-dimensional MMA calculator (outer-product type). The eight elements of the columns of the matrix A are divided into four groups of two elements, and one group is processed in one step (in other words, one step of the outer-product type is processed over four steps).

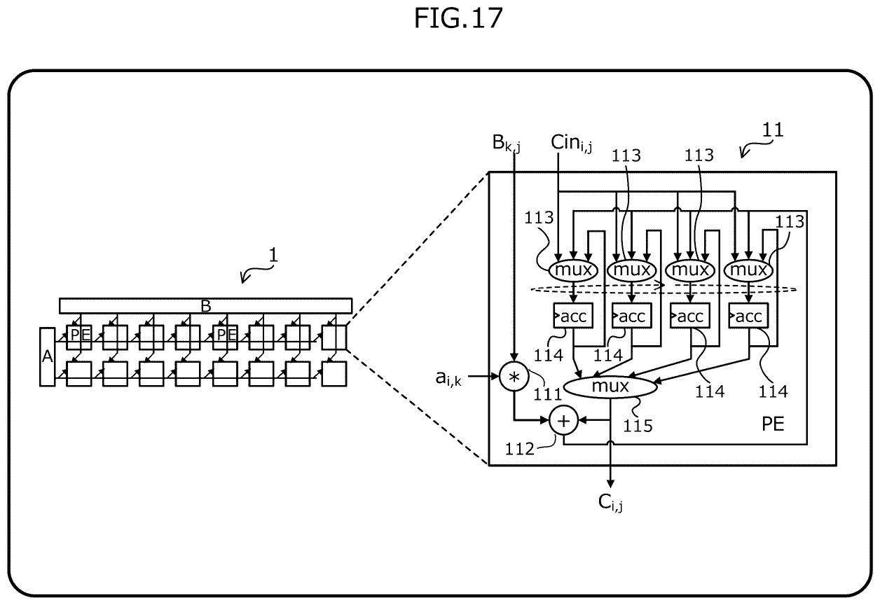

In each step, input data of the matrix A is input while being switched, and four accumulators (acc 114 described later with reference to FIG. 17) store the intermediate cumulative sum while being switched for each step.

For the matrix B, once one row is input, the same row is stored between four steps.

It is noted that, in FIG. 16, for the sake of simplicity, a case in which the matrix A side is input in a plurality of steps has been described, but the matrix A and the matrix B may be interchanged.

FIG. 17 is a block diagram schematically illustrating a configuration example of a PE 11 illustrated in FIG. 16.

The PE 11 is an example of a processing element and includes a multiplier 111, an adder 112, four muxes 113, four accs (accumulators) 114, and a mux 115. The multiplier 111 and the adder 112 may be EMA calculators.

The PE 11 is basically the same as the outer-product type in the related example in that a multiplier and an adder are provided and an EMA calculation is executed, but a calculation of one step of the outer product type is interleaved and executed in steps corresponding to the number of divisions. Therefore, in the PE 11, the acc 114 that stores the accumulation result of each region is provided for the number of divisions.

The multiplier 111 multiplies an input element A of one matrix and an input element B of the other matrix. The adder 112 adds the output of multiplier 111 and the output of the mux 115. The four muxes 113 select and output any one of Cin in which the output C is accumulated in the PE 11 and the output of the acc 114 and the output of the adder 112. When the four muxes 113 are, for example, ordered muxes 1131 to 1134 from the left, in order to correspond to a group of inputs A, in one cycle, the mux 1131 selects the output of the adder 112, and the remaining muxes 1132 to 1134 each select their own output of the acc 114. In the next cycle, the second mux 1132 from the left selects the output of the adder 112, and the remaining muxes 1131, 1133, and 1134 each select their own output of the acc 114. In this manner, the rectangular region is switched by cyclically selecting the output of the adder 112 for each cycle. The four accs 114 store the outputs of the four muxes 113, respectively. The mux 115 selects one of the outputs of the four accs 114 as a calculation result C.

In other words, the 1.5-dimensional MMA calculator 1 includes an array of l×m multiply-accumulate calculators 11 that perform the L×M×N matrix product calculation C=A*B or the L×M×N matrix multiply-accumulate calculation C=A*B+Cin by performing accumulations of the outer products Ok of k-th column of A and k-th row of B for 0≤k<N in the array of L×M accumulators with respect to the L×N matrix A, the N×M matrix B, the L×M matrix C, and the L×M matrix Cin, in which any one of l and m is l=L or m=M and the other one is 2≤l<L or 2≤m<M, and the l×m multiply-accumulate calculators 11 perform each of the accumulations of the outer products Ok by a plurality of steps. In addition, the l×m multiply-accumulate calculators execute the plurality of steps in a pipelined manner when performing each of the accumulations of the outer product Ok by the plurality of steps.

Although the example of the matrix product between square matrices has been mainly described above for simplicity, the two matrices may be L×N and N×M (L, M, and N are integers of 3 or more) matrices, respectively. The plurality of PEs 11 may be provided in an l×m number (l is an integer of 2 or more and less than L, and m=M). Each of the plurality of PEs 11 may include L/l or more of the plurality of accs 114. (1 and m may be interchanged)

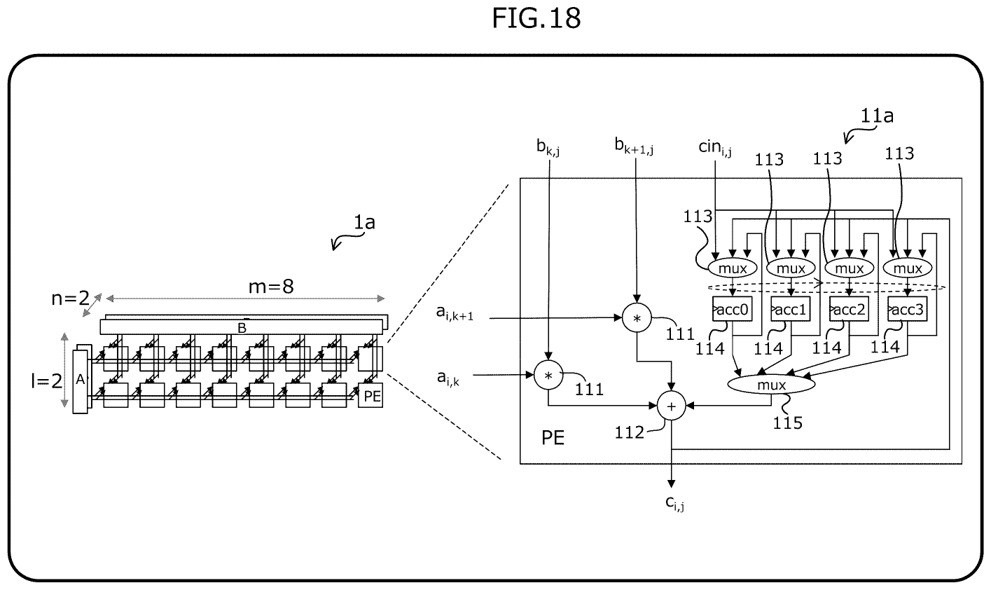

FIG. 18 is a block diagram schematically illustrating a configuration example of a PE 11a corresponding to that of FIG. 13, which has a thickness in the k-axis direction.

In a 1.5-dimensional MMA calculator 1a illustrated in FIG. 18, each of the plurality of PEs 11a may include n (n is an integer of 1 or more and N or less) FMA calculators. The acc 114 is shared by n EMA calculators, and processes n outer products in parallel. FIG. 18 illustrates an example of l×m×n=2×8×2, and two outer products are processed in parallel. Furthermore, in FIG. 18, the adder 112 has three inputs, two of which are connected to two multipliers 111, but may be configured by a tree of a usual two-input adder.

### [C] Effects

According to the matrix multiply-accumulate calculator in the above-described embodiment, for example, the following operational effects can be obtained.

The 1.5-dimensional MMA calculator 1 includes an array of l×m multiply-accumulate calculators that perform, when L and M are both integers of 2 or more and N is an integer of 1 or more, an L×M×N matrix product calculation C=A*B or an L×M×N matrix multiply-accumulate calculation C=A*B+Cin by performing accumulation of the outer product Ok of k-th column of A and k-th row of B in the array of L×M accumulators for an integer k of 0 or more and less than N, with respect to the L×N matrix A, the N×M matrix B, the L×M matrix C, and the L×M matrix Cin, in which any one of l and m is l=L or m=M and the other one is an integer of 2≤l<L or 2≤m<M, and the l×m multiply-accumulate calculators perform each of the accumulations of the outer products Ok by a plurality of steps.

As a result, the number of times of access to RF per multiply-accumulate calculation can be reduced.

In the 1.5-dimensional MMA calculator 1, each of the l×m multiply-accumulate calculators has a function to perform n (n is an integer of 2 or more and N or less, and N is an integer of 2 or more) multiplications and accumulation of the results of the multiplications, and the l×m multiply-accumulate calculators process accumulation of n outer products in parallel. As a result, as illustrated in FIG. 13, even in a case in which the one-step processing has a thickness in the k-axis direction, the number of EMA calculators included in the PE 11 can be appropriately set, and the number of times of RF access per FMA calculation can be reduced.

The l×m multiply-accumulate calculators execute a plurality of steps in a pipelined manner when accumulating the outer product Ok by the plurality of steps. As a result, the accumulation of the outer product Ok can be efficiently calculated.

### [D] Others

The disclosed technology is not limited to the above-described embodiments, and various modifications can be made without departing from the gist of the present embodiment. Each configuration and each processing of the present embodiment can be selected or omitted as needed, or may be appropriately combined.

In the above-described embodiments, the multiply-accumulate calculation of square matrices is executed, but the present embodiment is not limited thereto. In the above-described embodiment, a multiply-accumulate calculation of a square matrix and a matrix other than the square matrix may be executed, or a multiply-accumulate calculation of the matrices other than the square matrix may be executed.

In one aspect, the number of times of access to RF per multiply-accumulate calculation can be reduced.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A calculator comprising an array of l×m multiply-accumulate calculators configured to perform, when L and M are both integers of 2 or more and N is an integer of 1 or more, an L×M×N matrix product calculation C=A*B or an L×M×N matrix multiply-accumulate calculation C=A*B+Cin by performing accumulations of outer products Ok of k-th column of A and k-th row of B in an array of L×M accumulators for an integer k of 0 or more and less than N, with respect to an L×N matrix A, an N×M matrix B, an L×M matrix C, and an L×M matrix Cin, wherein
any one of l or m is l=L or m=M and the other one is an integer of 2≤l<L or 2≤m<M, and
the l×m multiply-accumulate calculators perform each of the accumulations of the outer product Ok by a plurality of steps.

2. The calculator according to claim 1, wherein
each of the l×m multiply-accumulate calculators has a function to perform n (n is an integer of 2 or more and N or less, and N is an integer of 2 or more) multiplications and accumulation of results of the multiplications, and
the l×m multiply-accumulate calculators process accumulation of n outer products in parallel.

3. The calculator according to claim 1, wherein
the l×m multiply-accumulate calculators execute the plurality of steps in a pipelined manner when accumulating the outer product Ok by the plurality of steps.

4. The calculator according to claim 2, wherein
the l×m multiply-accumulate calculators execute the plurality of steps in a pipelined manner when accumulating the outer product Ok by the plurality of steps.
